(19) United States
(12) Patent Application Publication
(10) Pub. No.: US 2008/0131638 A1
(43) Pub. Date: Jun. 5, 2008

(54) Multilayer barrier containers having increased adhesion and durability

(75) Inventors: Norman Hutton, Franklin Lakes, NJ (US); Paul Soskey, Neshanic Station, NJ (US); Danielle M. DeSalvo, Lake Hiawatha, NJ (US)

Correspondence Address: David W. Highet, VP & Chief IP Counsel;Becton, Dickinson and Company, 1 Becton Drive, MC 110, Franklin Lakes, NJ, 07417-1880, US

(73) Assignee: Becton, Dickinson and Company, Franklin Lakes, NJ (US)

(21) Appl. No.: 11/116,511

(22) Filed: Apr. 28, 2005

Related U.S. Application Data
(60) Provisional application No. 60/567,918, filed on May 4, 2004.

(51) Int. Cl. B32B 27/08; B32B 27/32; B29C 45/14

(52) U.S. Cl. 428/36.6; 428/500; 428/35.7; 264/259

(57) ABSTRACT

A technique is provided for decreasing the delamination of multilayered containers formed by coinjection. The multilayered container comprises at least a layer of hydrophilic copolymer and a layer comprising a blend of a polyolefin and an anhydride modified polyolefin. Desirably, the hydrophilic copolymer forms the core layer and the blend of a polyolefin and an anhydride modified polyolefin form the outer skin layers. The containers are suitable for blood collection, however they may be used for other applications as well.

### RELATED APPLICATION

This application claims priority to U.S. Provisional Patent Application No. 60/567,918, filed May 4, 2004.

### BACKGROUND OF THE INVENTION

1. Field of the Invention

The invention relates to decreasing the delamination of multi-layered containers formed by coinjection and thereby decreasing the permeability of containers to moisture and various gases such as oxygen. These containers can be used for various items such as food, drinks, cosmetics, and collection and containment of bodily fluids, such as blood.

2. Description of Related Art

All containers, regardless of their intended use, must meet performance standards to be acceptable for use. It is well known in the art to construct containers from various thermoplastics. It is also well known to employ containers of a multilayered structure to impart specific properties to the containers. Layers of different types of thermoplastics are commonly employed so that different advantages can be achieved from properties imparted through the various layers. For example, one layer may be resistant to moisture and another layer may be resistant to gas permeability.

For example, polypropylene (PP) has been used in molding and extruding operations for various articles, including plastic medical containers and films for the food packaging industry. However, PP is somewhat permeable to nitrogen, oxygen, and other gases and vapors. This permeation of gases can cause the sample encased in a PP container to degrade over the passage of time.

Such permeation of gases raises significant concerns in the medical industry. For example, evacuated blood collection tubes must meet certain performance standards. Such performance standards generally include the ability to maintain greater than about 90% original draw volume over a 12 to 18 month period. Therefore, a high level of gas permeability in a material selected for container construction is highly unfavorable, in that the vacuum may not be effectively maintained within the container over a long period of time. This requires a barrier to inhibit passage of atmospheric gases and moisture through the polymeric wall, which can reduce the draw volume and reduce the shelf life. Liquid vapor permeation through the tube wall must be similarly inhibited to reduce deterioration of dry blood analysis additives, or maintain critical liquid additives, frequently introduced into the tube at the time of manufacture.

One way to combat gas permeability is to use different layers of plastics so that the first layer of plastic can compensate for the second layer's gas permeability and the second layer can compensate for the first layer's moisture permeability. For example, ethyl vinyl alcohol (EVOH) materials exhibit good gas barrier qualities due to the presence of hydroxyl groups. Such materials, however are susceptible to moisture degradation, due in part to the presence of such hydroxyl groups.

Another concern is the reactivity properties of the container material with the contents. Multilayered containers constructed of different layers of polymers can maintain an inert surface and achieve the barrier properties that are required for such uses as blood collection.

Multilayered structures with EVOH as an internal layer and with PP external skin layers are commonly known in the art for providing containers with both gas and moisture barrier properties. However, the incompatibility and difference in chemical structures of the EVOH and PP layers makes such multilayered structures particularly susceptible to separation and delamination. Delamination of thermoplastic layers is further accelerated upon exposure to heat and/or mechanical stresses, and thereby destroys the synergistic effect of the multilayered structure.

There are various methods employed to combat the delamination of the layers, such as the addition of a tie or bonding layer, as described in U.S. Pat. No. 4,707,389. The tie layer is compatible with the two adjoining layers and in turn prevents delamination. However, employing a tie layer increases costs and increases the complexity of the machinery that creates the container.

Additives have been employed to decrease the delamination effects of multilayered films. For example, U.S. Pat. No. 5,230,963 discloses created packaging films by adding maleated polypropylene to a polypropylene layer which is then joined to another polypropylene layer by coating the mating surfaces of the layers with poly(vinyl alcohol). Such films are useful for flexible packaging needs, but are not useful for creating a container with a rigid structure.

There is a need for durable, sturdy containers that exhibit effective gas and moisture barrier properties, that are mechanically durable, and that are economical to produce.

### SUMMARY OF THE INVENTION

The invention addresses the problems of the prior art, and provides a process for fabricating improved containers meeting the needs discussed above. Such containers include, but are not limited to blood collection tubes, evacuated blood collection tubes, centrifuge tubes, culture bottles and syringe barrels.

In accordance with an embodiment of the invention, a process or method includes binding two dissimilar non-compatible layers, more particularly bonding a hydrophilic olefin copolymer layer such as ethylene vinyl alcohol, with a polyolefin layer such as polypropylene. The method involves blending an anhydride modified polyolefin resin as a compatibilizer with either the hydrophilic olefin copolymer resin or, more desirably, with the polyolefin resin. For example, a polyolefin resin can be blended with an anhydride modified polyolefin resin, such as blending polypropylene with maleated polypropylene, and then the blended resins can then be co-injected with a hydrophilic olefin copolymer resin (such as ethylene vinyl alcohol) through a co-injection process. The method produces a multilayer structure including a hydrophilic olefin copolymer layer bonded with a blended polyolefin layer, which structure exhibits excellent gas and moisture barrier properties, and which has durability and is not susceptible to delamination.

In a further embodiment of the invention, a multilayered structure is prepared through such a method. Accordingly, the structure includes a first layer including at least a hydrophilic olefin copolymer and a second layer directly adjacent the first layer and including a blend of a polyolefin and an anhydride modified polyolefin. A third layer, also including a blend of a polyolefin and an anhydride modified polyolefin, may further be provided adjacent the first layer on a side opposite the second layer. In such an arrangement, the first layer forms a core layer, while the second and third layers form inner and outer skin layers encompassing the core layer, with the structure free of any adhesive or tie layers between the core layer and the skin layers.

Desirably, the multilayered structure is in the form of a container, more desirably a tube, which includes a bottom wall, a top edge and a sidewall between the bottom wall and the top edge. At least the sidewall comprises inner and outer polymeric skin layers with a polymeric core layer located between and directly adjacent to the inner and outer polymeric skin layers. The skin layers and the core layer are formed from non-compatible polymers, but adhere well to each other and resist delamination due to the incorporation of an anhydride modified polyolefin into one of the resin layers, as noted above. Desirably, the core layer exhibits substantially continuous coverage throughout both the bottom wall and the sidewall, with the core layer encapsulated by the skin layers. As such, a co-injected tube having non-compatible polymers, yet without the need for adhesive or tie layers between the distinct polymers is thereby achieved.

In yet a further embodiment of the invention, a process or method of fabricating a multilayer container involves providing a first polymeric material comprising a hydrophilic olefin copolymer and a second polymeric material comprising a dry blend of a polyolefin and an anhydride modified polyolefin. The first and second molten polymeric materials are directed through a nozzle section into a mold cavity that comprises a region for integrally forming a bottom wall of the container. The first and second molten polymeric materials co-flow in the mold cavity for at least a portion of the fabrication process. During the co-flow, the nozzle section directs the first and second molten polymeric layers into the mold cavity as inner and outer skin layers of the first molten polymeric material with a core layer of the second molten polymeric material between the inner and outer skin layers.

### DETAILED DESCRIPTION

Generally speaking, in accordance with an embodiment of the present invention, multilayered container structures manufactured from two dissimilar non-compatible layers. (Non-compatible indicates polymers lacking good adhesion on a macroscale, meaning that upon formation of a two-layer film of two polymers, such polymers are considered non-compatible if they tend to delaminate immediately after the film-forming process or they tend to delaminate upon subsequent application of forces induced by normal handling, bending, object usage, changing environmental conditions (e.g., temperature change), or similar external factors.) More particularly, an embodiment of the present invention is directed to improved multilayered container structures which prevent or reduce delamination between layers.

In accordance with an embodiment of the present invention, multilayer container structures include at least one olefinic layer and at least one layer of a polymer which is non-compatible with the olefinic layer with respect to adherence and lamination. The multilayer container structures generally include at least a first and second layer which are directly adjacent to each other, with the first layer formed of a hydrophilic olefin copolymer and the second layer formed of a polyolefin. The multilayer container structure is formed through a co-injection process, where polymeric materials forming the layers of the structure co-flow into a mold of a desired shape to form the multilayer structure. Such a co-injection process is taught in PCT International Publication No. WO 02/102571, which discloses multilayer blood collection tubes manufactured through a co-flow co-injection process, and is incorporated herein in its entirety.

By incorporating an anhydride modified polyolefin resin into one of either the polyolefin layer or the hydrophilic olefin copolymer of such a multilayer structure, reduced delamination and improved adherence between such non-compatible layers can be achieved. Desirable results may be achieved when the anhydride modified polyolefin is incorporated into the polyolefin layer, such as by dry blending the anhydride modified polyolefin resin into the polyolefin resin prior to formation of the layer in the co-injection process.

The individual layers of the multilayer container of an embodiment of the invention are selected based on the contemplated use of the container. Containers according to the invention include, but are not limited to tubes, bottles, bowls, vials, flasks, syringes, and single use disposable containers. Particularly useful are those tubes used for blood collection. Embodiments of the invention are described below with respect to an evacuated blood collection tube, but it will be apparent to one skilled in the art that the description is equally applicable to other containers. The described embodiments are particularly useful for tubes, such as blood collection tubes, which are generally cylindrical in nature, with one rounded closed end and a continuous tubular cylindrical surface. In such instances, the finished container includes a continuous surface over a substantial shape, without any external threads or shapes which may traditionally be found on blow-molded containers.

For blood collection tubes, a combination of materials that inhibit gas and liquid vapor permeability are particularly useful. Materials suitable for the barrier layers include virgin polymers and copolymers having various linear or multi-branched molecular architectures or tacticites. The multilayer containers, in accordance with embodiments of the present invention, include at least two layers, with one layer being a hydrophilic olefin copolymer and the other layer being a polyolefin layer. The polyolefin layer desirably imparts liquid vapor barrier properties, while the hydrophilic olefin copolymer layer desirably imparts gas barrier properties.

The hydrophilic olefin copolymer useful for the first layer may be a copolymer of an olefin and one or more monomers selected from copolymers of vinyl alcohol, (meth)acrylic acid, (meth)acrylamide, allyl alcohol, hydroxy ethyl (meth)acrylate, and hydroxy propyl (meth)acrylate. Desirably, the olefin is ethylene, and more desirably the hydrophilic olefin copolymer is ethylene vinyl alcohol copolymer (EVOH). The EVOH polymer desirably includes about 27-48% vinyl alcohol, of which polymers within this range of content are commercially available.

The polyolefin useful as the second layer may be selected from polyethylenes such as HDPE, LDPE and LLDPE, polypropylene (PP), and cyclic olefin copolymers (COC). Desirably, the polyolefin is polypropylene.

As indicated, an anhydride modified polyolefin is incorporated into one of the layers of the container, desirably into the polyolefin layer. The anhydride modified polyolefin is desirably a maleated polyolefin, such as maleated polypropylene, maleated poly(ethylene-co-propylene), or similar modified propylene polymers or copolymers.

In one example, the hydrophilic olefin copolymer is EVOH, the polyolefin is PP and the anhydride modified polyolefin is maleated PP. As such, the first layer of a multilayer structure may include an EVOH layer and the second layer may include a blended layer of PP and maleated PP directly adjacent the first EVOH layer.

In some embodiments, the multilayer structure includes a three layer structure, with one of the materials forming a core layer sandwiched between two layers formed of the other material. For example, a core layer of EVOH may be sandwiched between two separate skin layers, both of which layers are a blend of PP and maleated PP on opposing sides of and directly adjacent the core layer. A core layer of blended PP/maleated PP sandwiched between skin layers of EVOH may also be provided. While it is contemplated that the structure may include tie layers in-between the core layer and either of first and second skin layers, such tie layers are not necessary or desirable, since the blended PP/maleated PP layer sufficiently binds with the EVOH layer so as to prevent delamination thereof.

Desirably, the polyolefin layer includes the polyolefin and anhydride polyolefin in the following amounts: the polyolefin is present in an amount from about 90 to about 98 weight percent and the anhydride modified polyolefin is present in each of the skin layers from about 2 to about 10 weight percent. The weight percents are based on the total weight of the combination of the polyolefin and the anhydride modified polyolefin. Greater amounts of anhydride modified polyolefin than 10 weight percent may be added, however, it is most cost effective to remain below 10 weight percent.

Organic or inorganic fillers, dyes, plasticizers, slip agents, processing aids, stabilizers and other small molecule additives may also be added to impart improved properties to one or more of the base polymers that comprise the layers of the container, and as used herein, the term polymeric material is intended to include polymers containing such additives. Other materials that may be of use include ultraviolet (UV) light barriers, molecular scavenger materials, radiation barrier materials, chargeable dyes (e.g. temperature sensitive), materials that react to temperature and/or pressure changes, and structural additives. It is also possible to use nanocomposites of the base polymers described above. Nanocomposites containing small amounts of clay (1-5%) have been shown to yield large improvements in barrier properties. A clay commonly used in these nanocomposites is organically modified montmorillonite, a mica-type silicate, which consists of sheets arranged in a layered structure. Nanoclays are used due to their high cation exchange capacity, high surface area and large aspect ratio with a platelet thickness of 100 nm. The large aspect ratio of the silicate layers force gas and liquid molecules to follow a more tortuous path in the polymer matrix around the silicate layers promoting much larger diffusion distances, thereby lowering permeability. Orientation effects of the polymer matrix itself, also appears to lower the permeability of gas and liquid vapor molecules through the matrix. Numerous combinations of materials are also possible, disposed in any multilayer configuration, in the containers of the embodiments described herein.

A feature of the multilayer container of the described embodiments, particularly for evacuated blood collection tubes, is the coverage of each material. (Coverage, as used herein, indicates that a material is found in a cross-section of the container.) For example, if a liquid vapor barrier material is absent from a portion of the container, liquid vapor may escape. Thus, for some applications, it is important to have substantially continuous coverage of both a liquid vapor barrier material and a gas barrier material throughout both the bottom wall and throughout the side wall (throughout the side wall means, in one embodiment up to within approximately 0.1 inches of the top edge; in another embodiment the coverage is within approximately 0.02 inches of the top edge). Alternatively, it is possible to instead provide substantially continuous coverage of both materials up the sidewall only to a region of the container that will be contacted (e.g. sealed) by a stopper, since the presence of the stopper may provide sufficient barrier properties. (Substantially continuous coverage indicates, in an embodiment of the invention, that a material is found in at least 98% of the cross-section of the defined areas). The formation process can be performed to provide the desired coverage.

Depending on the materials used, it may also be desirable to encapsulate the core material, such that the amount of core material exposed to the outside environment is kept low. For example, if a particular property of a core material is affected by moisture present in the air, the formation process should be controlled such that the skin material substantially encapsulates the core material, thereby reducing or preventing exposure of the core material to the outside environment. Such encapsulation further assists in restraining the core from delamination. In a skin-core-skin embodiment, where encapsulation and substantially continuous coverage are desired, the core material is present in all but the top edge of the container, and this top edge would instead have a cross-section of only the skin material. Incorporating the anhydride-modified polyolefin into one of the layers imparts a chemical compatibility between the layers to prevent delamination of the core material at the interface of the core and skin layers, while encapsulation further provides a mechanical structure to further inhibit delamination.

In one embodiment of the present invention, the multilayer container structure is in the form of a tube, and in particular, a tube useful for blood collection.

Containers, in accordance with embodiments of the invention, are generally fabricated by coinjection molding, which is a process by which at least two separate injection moldable materials are combined prior to the mold gate in an orderly one step molding operation, in which the material co-flows for at least a portion of the operation. Such a co-flow, co-injection process is described in PCT International Publication No. WO 02/102571 and in U.S. Pat. No. 5,914,138, the disclosure of both of which are incorporated herein by reference. In particular, coinjection molding makes it possible to form an entire tube, including a closed, rounded bottom, in a single step, with desired coverage and desired encapsulation of the core layer. No preform is needed. The bottom wall can be provided by using a mold cavity having a region for forming the closed bottom wall in a manner integral with the steps of flowing the polymer into the mold cavity. Desired coverage and/or encapsulation is achieved by controlling the flow of the various materials.

The container structure may be entirely constructed of the multiple layers of polymers. In other words, the bottom wall and the sidewalls, which extend from the bottom wall to the top edge of the container, may be entirely constructed of multiple layers. Another structural embodiment may include only the sidewalls being made of multiple layers. In yet another embodiment, the container may be a collection tube, wherein the sidewalls extend down from the top edge to form the round bottom portion of the collection tube. The round bottom portion of the collection tube may or may not be entirely made of multiple layers. Desirably, the multiple layers include inner and outer skin layers (i.e., inside the tube and outside the tube) of at least a polyolefin and an anhydride modified polyolefin, and a core layer comprising at least a hydrophilic olefin copolymer.

As described above, one method of constructing the multiple layered container includes a coinjection molding process. In such a process, the hydrophilic olefin and polyolefin/anhydride modified polyolefin blend are co-injected to form multiple layers. The polyolefin and anhydride modified polyolefin is dry blended prior to the coinjection process. Coinjection of the hydrophilic olefin resin with the dry-blended polyolefin/anhydride modified polyolefin resin blend allows the two dissimilar materials to develop a bond. This is due to, the materials being at a high enough temperature such that the molecules are still able to move about somewhat within the structure. Accordingly, the anhydride modified polyolefin has an opportunity to align itself within the polyolefin layer and create entanglements within the boundary of the two joined layers, thus creating a connection or bond between the two dissimilar layers.

For example, polypropylene is hydrophobic and ethylene vinyl alcohol is hydrophilic. The addition of the maleated polypropylene, which possesses both properties, allows the polypropylene layer to adhere more firmly to the ethylene vinyl alcohol layer. The higher temperature of the coinjection process allows the maleated polypropylene to migrate throughout the polypropylene layer and form bonds with the ethylene vinyl alcohol layer. This creates a more durable container that is resistant to gas permeation and moisture permeation, and has an inert surface that preserves the integrity of the contents.

In accordance with an embodiment of the invention, tie layers are not required, even though two dissimilar materials are being bonded, because of the addition of the anhydride modified polyolefin to the polyolefin layer.

The multilayered container of the described embodiments may be desirably formed as a tube through coinjection techniques set forth in detail in PCT International Publication No. WO 02/102571. For example, a specific method for fabricating a multilayered container having a bottom wall, a top edge, and a sidewall between the bottom wall and top edge, may include the steps of providing a first molten polymeric material comprising a hydrophilic olefin copolymer, and providing a second molten polymeric material comprising a blend of a polyolefin and an anhydride modified polyolefin. The first and second molten polymeric materials are directed through a nozzle section into a mold cavity that comprises a region for integrally forming the bottom wall of the container, such that the first and second molten polymeric materials co-flow in the mold cavity for at least a portion of the fabrication process.

The containers of the described embodiments are capable of being formed in any desired size. For example, a tube according to the invention is capable of being formed as a conventional evacuated tube 50-150 mm in length and 10-20 mm internal diameter. In particular, standard evacuated tubes, which are 75-100 mm in length and have a 13-16 mm internal diameter, or standard microcollection tubes, which are 43.18 mm long and have a 6.17 mm internal diameter are possible. Typical wall thicknesses of conventional blood collection tubes, e.g., about 25 mils (0.625 mm) to about 80 mils (2.032 mm), more typically about 30 mils (0.762 mm) to about 40 mils (1.016 mm), are possible in tubes according to the described embodiments. In a three-layer tube of the invention, for example, it is possible to have a core layer about 0.1 mils (0.00254 mm) to about 20 mils (0.508 mm) thick, typically about 1 mils (0.0254 mm) to about 3 mils (0.0762 mm) thick, with each skin layer being about 8 mils (0.2032 mm) to about 40 mils (1.016 mm) thick, typically about 10 (0.254 mm) to about 30 mils (0.762 mm) thick.

For use in the specimen collection field, the container of the described embodiments generally must go through additional processing steps. For example, additives useful in blood or urine analysis, e.g., procoagulants or anticoagulants, are often disposed into the tube. As known in the art, blood analysis is often performed on serum, and procoagulants are typically used to enhance the rate of clotting. Such procoagulants include silica particles or enzyme clot activators such as elagic acid, fibrinogen and thrombin. If plasma is desired for analysis, an anticoagulant is generally used to inhibit coagulation, such that blood cells can be separated by centrifugation. Such anticoagulants include chelators such as oxalates, citrate, and EDTA, and enzymes such as heparin.

Additives are disposed in the containers in any suitable manner, liquid or solid, including dissolution in a solvent, or disposing in powdered, crystallized or lyophilized form.

It is also possible to include separators in the container, e.g., density gradient separators in mechanical or non-mechanical form (e.g., thixotropic gels). Such separators provide for cell separation or plasma separation, for example.

In addition, assembly of the container may further include placing an elastomeric closure over the open end of the container and reducing the internal pressure of the container, such as by placing the container in an evacuation chamber to reduce the internal air pressure within the container to a level which is lower than atmospheric pressure.

In accordance with an embodiment of the present invention the addition of an anhydride modified polyolefin such as maleated polypropylene in the manner as described above enables the containers to resist delamination when under applied loads, as well as when exposed to extreme and/or rapid changes in temperature, such as those that can occur during shipping and storage. For example, PP/EVOH tubes can delaminate when exposed to extreme temperature changes, such as a change in temperature of greater than about 50° F. over a period of less than about 12 hours. Such delamination caused by extreme temperature changes, as well as other delamination concerns such as from applied pressure, may be prevented by incorporating an anhydride modified polyolefin into one of the skin or core layers, such as adding maleated PP to PP for use as skin layers enveloping a EVOH core layer.

Embodiments of the present invention will be further exemplified through the following examples. Unless otherwise indicated in the examples and elsewhere in the specification and claims, all parts and percentages are by weight, temperatures are in degrees centigrade, and pressures are at or near atmospheric pressure.

### EXAMPLES

### Example 1

Three layer tubes of EVOH core material and PP skin material, without the addition of any maleated PP included in any of the layers as a compatibilizer, were fabricated according to the coinjection process described above. The tubes were 13 mm×75 mm, 2.0 ml draw tubes, with wall a thickness of 2.032 mm or 0.080 inches. The tubes were constructed with varying amounts (volume percent) of EVOH present based on the total structure of the tube.

In order to test the ability of the tube to withstand loads from the side, the tube was laid on its side (without a stopper) and force was applied perpendicular to the tube at a point between the center of the tube and the top of the tube using an Instron machine. To test the ability of the tube to withstand radial loads, which mimics the force of the stopper, a probe was inserted inside the tube which applied pressure at the top (open end) of the tube. Delamination was determined by a visual inspection of the tubes. In particular, the tubes become opaque at the points where the layers of the tubes delaminate.

The chart below summarizes the results. The material composition of the tubes are listed below with the percentage EVOH being the core layer and the balance being PP skin layers.

TABLE 1

| | Average radial load | Average side load |
|---|---|---|
| Material composition of | applied at point of | applied at point of |
| tube | delamination (lbs) | delamination (lbs) |
| 2% EVOH core/98% PP skins | 82.39 | 16.5 |
| 5% EVOH core/95% PP skins | 84.22 | 16.3 |
| 8% EVOH core/92% PP skins | 75.04 | 16.5 |

As can be seen from the above results, each of the tubes constructed without the addition of any compatibilizer delaminated at forces of less than 17 lbs when side loaded, and delaminated at forces less than 85 lbs when loaded radially.

Moreover, in order to test the ability of the tube to withstand temperature extremes, the tubes were taken from a 21° C. environment (room temperature) and placed in an environment of about −60° C. for about 12 hours to simulate a rapid temperature change such as during storage. Upon visual observation after about 12 hours, each of the tubes demonstrated delamination of the layers.

### Example 2

Dry blends of PP and maleated PP resins were prepared at varying levels. Three layer tubes were fabricated according to the coinjection process described above, with EVOH resin provided as the core material and the blend of PP/maleated PP resin provided as the skin material, with the maleated PP resin acting as a compatibilizer. The material composition of each tube tested is described in Table 2 below, with 5% EVOH present based on the total structure of the tube, and with varying amounts of maleated PP incorporated into the skin layers, representing volume percent based on the skin layer volume. The tubes were 13 mm×75 mm, 2.0 ml draw tubes, with a wall thickness of 0.080 inches or 2.032 mm.

Applied load and temperature tests were performed on each of the tubes in the same manner as in Example 1, with the results shown in Table 2.

TABLE 2

| | Average radial load | Average side load |
|---|---|---|
| Material composition of | applied at point of | applied at point of |
| tube | delamination (lbs) | delamination (lbs) |
| 5% EVOH core/95% skin | 180.6 | 62.9 |
| layer incorporating 2% | | |
| maleated PP | | |
| 5% EVOH core/95% skin | 221.9 | 128.8 |
| layer incorporating 5% | | |
| maleated PP | | |
| 5% EVOH core/95% skin | no delamination | 147.8 |
| layer incorporating 10% | detected (max force | |
| maleated PP | of 228.8 lbs applied) | |

A comparison of the results of Examples 1 and 2 demonstrates that the addition of maleated PP as a compatibilizer to the polypropylene results in improved properties, in that the tubes delaminated when significantly higher side and radial loads were applied compared to the tubes in Example 1. In particular, as compared to the tube consisting of 5% EVOH in Example 1, the tubes in Example 2 withstand significantly higher loads before delaminating. Further, the tubes in Example 2 including 10% of the maleated PP added to the PP skin layer withstood 228.8 pounds of pressure applied radially with no delamination detected.

Additionally, when the tubes of Example 2 were subjected to extreme temperature changes in a similar manner as in Example 1, no delamination between the layers was detected.

### Example 3

A dry blend of EVOH and maleated PP resin was prepared. Three layer tubes were fabricated according to the coinjection process described above, with PP resin provided as the skin material and the blend of EVOH/maleated PP resin provided as the core material, with the maleated PP resin acting as a compatibilizer. The material composition of each tube tested is described in Table 3 below, with 5% EVOH present based on the total structure of the tube, and with varying amounts of maleated PP incorporated into the core layer representing volume percent based on the core layer volume. The tubes were 13 mm×75 mm, 2.0 ml draw tubes, with a wall thickness of 0.080 inches or 2.032 mm. The tubes were tested in the same manner as Examples 1 and 2 and the results are summarized in Table 3 below.

TABLE 3

| | Average radial load | Average side load |
|---|---|---|
| Material composition of | applied at point of | applied at point of |
| tube | delamination (lbs) | delamination (lbs) |
| 5% EVOH core layer | 120.6 | 12.67 |
| incorporating 2% maleated | | |
| PP/95% PP skin layers | | |
| 5% EVOH core layer | 107.7 | 15.5 |
| incorporating 5% maleated | | |
| PP/95% PP skin layers | | |
| 5% EVOH core layer | 160.3 | 36.7 |
| incorporating 10% maleated | | |
| PP/95% PP skin layers | | |

A comparison of the results of Examples 1 and 3 demonstrates that the addition of the maleated PP to the EVOH core layer allowed the tube to withstand higher radially applied loads as compared to the 5% EVOH tube in Example 1. In the side load test, the addition of the maleated PP at the 10% level outperformed the 5% EVOH tube in Example 1.

Additionally, when the containers were subjected to extreme changes in temperature as in Examples 1 and 2, the tubes of Example 3 did not delaminate.

Although illustrative embodiments of the present invention have been described herein with reference to the examples, it is to be understood that the invention is not limited to those precise embodiments, and that various other changes and modifications may be effected therein by one skilled in the art without departing from the scope or spirit of the invention.

What is claimed:

1. A multilayered structure comprising:
a first layer comprising at least a hydrophilic olefin copolymer; and
a second layer directly adjacent the first layer, said second layer comprising at least a blend of a polyolefin and an anhydride modified polyolefin.

2. The multilayered structure of claim 1, further comprising a third layer directly adjacent the first layer on a side opposite said second layer, said third layer comprising a blend of a polyolefin and an anhydride modified polyolefin.

3. The multilayered structure of claim 2, wherein the first layer comprises a core layer, and wherein the second and third layers comprise inner and outer skin layers directly adjacent the core layer.

4. The multilayered structure of claim 3, wherein the structure is free of adhesive or tie layers between the core layer and the skin layers.

5. The multilayered structure of claim 4, wherein the first layer comprises a core layer comprising ethylene vinyl alcohol, and wherein the second and third layers comprise inner and outer skin layers directly adjacent the core layer, and wherein each of the skin layers comprise a blend of polypropylene and maleated polypropylene.

6. The multilayered structure of claim 1, wherein the polyolefin is polypropylene.

7. The multilayered structure of claim 1, wherein the anhydride modified polyolefin is maleated polypropylene.

8. The multilayered structure of claim 1, wherein the hydrophilic olefin copolymer is a copolymer of an olefin and one or more monomers selected from the group consisting of a copolymer of vinyl alcohol, (meth)acrylic acid, (meth)acrylamide, allyl alcohol, hydroxy ethyl (meth)acrylate, and hydroxy propyl (meth)acrylate.

9. The multilayered structure of claim 8, wherein the olefin is ethylene.

10. The multilayered structure of claim 9, wherein the hydrophilic olefin copolymer is ethylene vinyl alcohol.

11. The multilayered structure of claim 1, wherein the polyolefin is present in the second layer from about 90 to about 98 weight percent, based on the total weight of the second layer, and wherein the anhydride modified polyolefin is present in the second layer from about 2 to about 10 weight percent, based on the total weight of the second layer.

12. A multilayered container comprising:
a bottom wall, a top edge, and a sidewall between the bottom wall and the top edge,
wherein at least the sidewall comprises inner and outer polymeric skin layers comprising a blend of a polyolefin and an anhydride modified polyolefin, with a polymeric core layer comprising a hydrophilic olefin copolymer located between and directly adjacent the inner and outer polymeric skin layers.

13. The multilayered container of claim 12, wherein said bottom wall, said top edge, and said sidewall are free of adhesive or tie layers between the core layer and the skin layers.

14. The multilayered container of claim 12, wherein the polyolefin is polypropylene.

15. The multilayered container of claim 12, wherein the anhydride modified polyolefin is maleated polypropylene.

16. The multilayered container of claim 12, wherein the hydrophilic olefin copolymer is a copolymer of an olefin and one or more monomers selected from the group consisting of a copolymer of vinyl alcohol, (meth)acrylic acid, (meth)acrylamide, allyl alcohol, hydroxy ethyl (meth)acrylate, and hydroxy propyl (meth)acrylate.

17. The multilayered container of claim 16, wherein the olefin is ethylene.

18. The multilayered container of claim 17, wherein the hydrophilic olefin copolymer is ethylene vinyl alcohol.

19. The multilayered container of claim 12, wherein the polyolefin is present in each of the skin layers from about 90 to about 98 weight percent, based on the total weight of each of the skin layers, and wherein the anhydride modified polyolefin is present in each of the skin layers from about 2 to about 10 weight percent, based on the total weight of each of the skin layers.

20. The multilayered container of claim 12, wherein the core layer comprises ethylene vinyl alcohol, and wherein each of the inner and outer skin layers comprise a blend of polypropylene and maleated polypropylene.

21. The multilayered container of claim 12, wherein the container is formed by a coinjection process.

22. The multilayered container of claim 12, wherein the sidewall and the bottom wall comprise inner and outer polymeric skin layers comprising a blend of a polyolefin and an anhydride modified polyolefin, with a polymeric core layer comprising a hydrophilic olefin copolymer located between and directly adjacent the inner and outer polymeric skin layers.

23. The multilayered container of claim 12, wherein the core layer exhibits substantially continuous coverage throughout both the bottom wall and the sidewall.

24. The multilayered container of claim 23, wherein the core layer is encapsulated by the skin layers.

25. The multilayered container of claim 12, wherein the core layer exhibits substantially continuous coverage throughout the bottom wall and in the sidewall up to a region of the container that is designed to be contacted by a stopper.

26. The multilayered container of claim 12, wherein the container is a tube.

27. The multilayered container of claim 26, wherein the tube further includes a cap having an elastomeric region.

28. The multilayered container of claim 27, wherein the tube is an evacuated blood collection tube.

29. A method for binding a hydrophilic olefin copolymer layer with a polyolefin layer in a co-injection process comprising blending a polyolefin resin with an anhydride modified polyolefin resin, and co-injecting the blended resins with a hydrophilic olefin copolymer resin through a co-injection process.

30. The method of claim 29, wherein the hydrophilic olefin copolymer is a copolymer of an olefin and one or more monomers selected from the group consisting of a copolymer of vinyl alcohol, (meth)acrylic acid, (meth)acrylamide, allyl alcohol, hydroxy ethyl (meth)acrylate, and hydroxy propyl (meth)acrylate.

31. The method of claim 30, wherein the olefin is ethylene.

32. The method of claim 29, wherein the hydrophilic olefin copolymer is ethylene vinyl alcohol.

33. The method of claim 29, wherein the polyolefin is polypropylene.

34. The method of claim 29, wherein the anhydride modified polyolefin is maleated polypropylene.

35. A method for fabricating a multilayered container having a bottom wall, a top edge, and a sidewall between the bottom wall and top edge, comprising the steps of:
providing. a first molten polymeric material comprising a hydrophilic olefin copolymer; and
providing a second molten polymeric material comprising a blend of a polyolefin and an anhydride modified polyolefin;
directing the first and second molten polymeric materials through a nozzle section into a mold cavity that comprises a region for integrally forming the bottom wall of the container, wherein the first and second molten polymeric materials co-flow in the mold cavity for at least a portion of the fabrication process.

36. The method of claim 35 wherein the inner and outer skin layers are directly adjacent to the core layer.

37. The method of claim 35, wherein the hydrophilic olefin copolymer is a copolymer of an olefin and one or more monomers selected from the group consisting of a copolymer of vinyl alcohol, (meth)acrylic acid, (meth)acrylamide, allyl alcohol, hydroxy ethyl (meth)acrylate, and hydroxy propyl (meth)acrylate.

38. The method of claim 37, wherein the olefin is ethylene.

39. The method of claim 38, wherein the hydrophilic olefin copolymer is ethylene vinyl alcohol.

40. The method of claim 35, wherein the polyolefin is polypropylene.

41. The method of claim 35, wherein the anhydride modified polyolefin is maleated polypropylene.
